(19) United States
(12) Patent Application Publication
(10) Pub. No.: US 2002/0121113 A1
(43) Pub. Date: Sep. 5, 2002

(54) Device for purifying molten glass

(76) Inventors: Dirk Gohlke, Mainz (DE); Jorg Witte, Darmstadt (DE); Nicole Surges, Munster-Sarmsheim (DE); Paul Kissl, Mainz (DE); Wolfgang Muschick, Budenheim (DE); Hildegard Romer, Karben (DE)

Correspondence Address: MERCHANT & GOULD P.C., P.O. Box 2903, Minneapolis, MN, 55402-0903, US

(21) Appl. No.: 09/945,321

(22) Filed: Aug. 31, 2001

(30) Foreign Application Priority Data
Sep. 1, 2000 (DE) 100 42 975.0
Sep. 21, 2000 (DE) 100 46 709.1

(51) Int. Cl. C03B 5/225

(52) U.S. Cl. 65/134.4; 65/134.5; 65/346; 65/347

(57) ABSTRACT

The invention relates to a device for purifying molten glass;

with a bubble dispenser for generating gas bubbles from an external source as well as for introducing these bubbles into the molten mass;

with a pressurized-gas source arranged prior to the bubble dispenser;

the bubble dispenser comprising a porous body with open pores;

the pores of the porous body 2 having an average diameter of less than 0.5 mm.

The invention relates to a device for purifying inorganic compounds in molten form, in particular molten glass.

In the production of glass, it is necessary to follow the melting process with a purification process. In this, the purification has the task of freeing the melted glass from physically and chemically bound gasses. The gasses must be removed in order to ensure that the quality of the end product is not diminished.

Numerous methods and devices for purification are known. In this context, there are two basic possibilities, which can be applied in common or separately from each other.

In the case of chemical purification methods, chemical purification agents are added to the molten glass. Used as purification agents are As₂O₃, Sb₂O₃, Na₂SO₄, NaCl, or mixtures of these. These substances decompose in a temperature range typical for them, while forming gaseous components (oxygen, sulfur dioxide, hydrochloric acid). A problem consists in the fact that the bubble formation is determined in essence through the decomposition temperature and can scarcely be influenced. It is desirable, however, to be able to intentionally make bubbles arise at particular locations.

The application of arsenic-or antimony-containing purification agents presents a problem with respect to environmental compatibility, both in the molten process and in the product. Aimed at are methods that do without the addition of toxic substances and in which no environmentally harmful substances are released.

A further possibility of expelling the gas components from the molten glass consists in the fact that glass bubbles are intentionally introduced into the molten glass by injecting external gases (jet-bubble process, bubbling) and an exchange of material is effected. Due to the size of the bubbles, in the first place a convection is forced in the molten material. Acting as the driving force for the material transport from the molten material into the bubble is the concentration difference between the gasses dissolved in the molten material and the concentration of the gasses in the bubble. The diffusing in of gaseous components is associated with an expansion of the bubble, which expansion leads to an increasing of the rate of advancement. A very effective material exchange between molten material and bubble is achieved through a large specific surface (very many small bubbles). Since the bubbles introduced into the molten material display a large diameter (∅˜10 cm to 30 cm), the exchange of material and thus the purification effect is relatively small (small specific surface).

Examples of purely physical purification methods by the introduction of external gas and generation of gas bubbles from this are described in DE 199 35 686 A1, DE 43 13 217 C1, and EP 0 915 062 A1. Used as bubbling gases are air or oxygen.

To be sure, described in EP 0 915 062 A1 is the fact that through variation of the water content in the bubbling gas the size of the bubbles can be influenced; however, the influenceability is limited and at normal molten viscosities, using conventional bubbling jets with a gas opening in the range of 0.1 to 10 mm, bubble diameters under 5 cm can scarcely be achieved. Moreover, the water atmosphere in the bubbling gases possibly leads to negative, undesired effects such as water accumulations in the molten glass, which can negatively influence the characteristics of the glass.

Efforts to minimize the size of the gas bubbles of the externally injected gas have not been lacking. However, this has proved very difficult. That is to say, the viscosity and the surface tension of the molten glass ensures that the bubble size cannot be reduced below a certain value. Moreover, the minimizing of the bubble size comes up against purely mechanical limits. That is to say, only a certain number of jets of small diameter can be accommodated on the surface available. Furthermore, the following has become evident: Even when, by great efforts with respect to apparatus, bubbles of relatively small diameter are successfully produced, these latter immediately after their formation accumulate against each other, so that from this once again larger bubbles arise. It is therefore not possible with the hitherto available means to generate in a lasting manner a number of small bubbles.

In summary, the following can be stated: Bubbling devices of the type mentioned have, indeed, the advantage that they are free from toxicity. However, in practice they are not truly effective and frequently must be supported additionally by chemical purification means.

The invention is based on the task of specifying a device for purifying molten masses of ceramic as well as of metallic material, in particular molten glass, which device does not exhibit the disadvantages of the chemical purification agents, but which brings about an effective purification.

This task is accomplished through the features of claim 1.

The inventors have recognized, first of all, that bubbles formed from external gas have continued existence in the molten mass only once a certain smallness is achieved. The bubble size need only be sufficiently greatly reduced. A dramatic reduction of the bubble diameter relative to the values produced hitherto leads to a relatively stable bubble formation.

The second step consists, according to the invention, in the selection of an appropriate bubble dispenser for generating the above-mentioned mini gas-bubbles as well as for their injection into the molten mass. Such a dispenser consists of a body with pores—see the specification as well as the claims.

The material of the porous body can be of any kind. Two important main groups are bodies of ceramic material as well as bodies of metals.

In this context, different manners of production come into consideration, which lead to different structures of the porous bodies. If one uses ceramic materials, then coming into consideration are primarily frits. If one uses metallic materials, then structures such as wire meshes, lattices, grids, or gratings can be selected.

If metal is used as the material of the porous body, then the following has become evident in practice:

Porously sintered frits, round blanks, or pipes with porous walls of refractory metals, above all of alloys based on tungsten, molybdenum, platinum, iridium, and rhodium can be used for the purpose of producing intentionally small bubbles in the molten glass, which bubbles aid the purification process of the molten material. The investigated fritted discs displayed a porosity of 10% to 40% and have a pore size of 5 μm to 30 μm. The sintering of tungsten and molybdenum at 1900° C. or at 1800° C. leads to the fact that in application in the molten glass at temperatures below ˜1600° C., no after-sintering is to be expected. The sintering-closed of platinum-rhodium alloys and rhodium during application in the molten glass can likewise be prevented when the fritted discs are appropriately sintered at temperatures above 1600° C. In addition, platinum-rhodium alloys with a high rhodium share (>20% by weight) have proved in application at temperatures around 1500° C. to be stable with respect to after-sintering in the molten glass. The stability with respect to after-sintering of noble-metal fritted discs depends on the output grain size of the noble-metal powder and the sintering temperature. Pure rhodium fritted discs display the highest stability.

Bubbles can also be generated with run-through, tightly woven grid bodies of platinum-rhodium alloys. The grid body is constructed of several grid layers. The individual layers possess different mesh sizes. The side facing the molten glass displays the smallest mesh size (<1 μm). The layers arranged below this serve as a carrier-and-support structure. A sintering-closed can likewise be prevented when an annealing takes place beforehand and alloys with a high rhodium share are used. An advantage of fritted discs and grids of platinum-rhodium alloys with respect to tungsten and molybdenum is represented by the low susceptibility to oxidation through oxygen.

A closing up of the pores through infiltration with fused glass is not observed. Through direct current flow (resistance heating), the mesh or grid can in addition be heated, so that the viscosity of the glass at the boundary surface can be further reduced and the formation of smaller bubbles is promoted.

Investigations of flow-through fritted discs and grids were carried out in a model liquid (PEG/water). The viscosity of the model liquid was varied over a broad range, and covered the range of the viscosity of molten glass (η˜1 Pas to η˜10 Pas). Bubbles with a diameter of ˜1 mm to ˜20 mm are formed, and can be adjusted by the throughflow and/or through the operating pressure.

The advantages of the application of metallic materials relative to ceramic materials lie in the following:

Compared with porous ceramic fritted discs, fritted discs of Mo, W or noble metals exhibit a good corrosion resistance in the molten glass and can, in addition, be heated in direct current flow (resistance heating).

Especially advantageous are noble metals or grid bodies, since they permit the application of purging gas containing oxygen.

Considered generally, the invention possesses the following advantages:

Locationally targeted introduction of small bubbles.

Creation of a large specific contact or exchange surface between bubble and molten mass—good purification effect.

With respect to the development of low-pressure purification processes, this method has application potential. This method can be used for the introduction into the molten mass of small bubbles, which act as nucleating agents, before putting the inlet of the low-pressure unit into the melt.

No introduction or release of toxic or environmentally harmful substances.

The following table reproduces practical experiences that were made with different ceramic materials:

| | | PORE SIZE | BUBBLE Ø | |
|---|---|---|---|---|
| FILTER TYPE | MATERIAL | [μm] | [m] | OBSERVATIONS |
| L3-SiC | silicon | 1 | 1 | Many fine bubbles form |
| | carbide | | | uniformly over the entire |
| | | | | filter surface. |
| SiC | silicon | 100 | 5-10 | Most of the bubbles collect |
| | carbide | | | in a short time and rise up |
| | | | | as a cluster or giant bubble. |
| A 253- | aluminum | 100 | 10 and > | Marble-sized bubbles rise |
| Al₂O₃ | oxide | | | up individually. |
| S 910 | silicon | 100 | 10 and > | The pressure does not change |
| | carbide | | | with increasing flow-through. |
| | | | | Very large bubbles rise up |
| | | | | individually or as a group. |
| Al 25 | aluminum | 5-20 | 2-20 | Most of the bubbles combine |
| | | (20-30%) | | in a short time above the filter |
| | | | | and rise up as a very |
| | | | | large bubble. |
| Quarzal | silicon | ? | 1 | The bubbles build up |
| | dioxide | (9-12%) | | primarily on the boundary |
| | | | | of the rubber seal of the |
| | | | | filter. The gas seems to |
| | | | | not pass through the |
| | | | | Quarzal. |
| Alsint pipe | aluminum | 1.5 | 1-2 | A very dense, uniform |
| | oxide | | | bubble skin with fine |
| | | | | bubbles emerges from |
| | | | | the pipe surface. They |
| | | | | still emerge even with |
| | | | | falling pressure (after |
| | | | | the switch-off), uniformly |
| | | | | but more slowly. |
| Al₂O₃ pipe | aluminum | | | The bubbles emerge |
| | oxide | | | uniformly and small |
| | | | | (diameter ca. 1 mm) from |
| | | | | the surface. |
| Silimantine | aluminum | 2 | 1-2 | Similar to the Alsint pipe. |
| 60 pipe | silicate | | | It appears that once the |
| | | | | gas starts to flow through |
| | | | | the filter, the bubbles |
| | | | | emerge continuously. |
| Silimantine | aluminum | 8-9 | 1-3 | At 2 liters/mm, similar |
| 60 NG pipe | silicate | | | to the above-mentioned. |
| | | | | At 4 liters/mm, the |
| | | | | bubbles rise up more |
| | | | | quickly. Due to the |
| | | | | high rate, they converge |
| | | | | and thereby become |
| | | | | larger. |
| SiC pipe | silicon | ? | 2-4 | Fine bubbles appear |
| | carbide | (ca. 10%) | | uniformly everywhere. |
| | | | | At 6 liters/mm, so |
| | | | | quickly that they |
| | | | | collect just as the |
| | | | | above-mentioned. |

The invention is explained with the aid of the drawings. In them, the following are represented in detail:

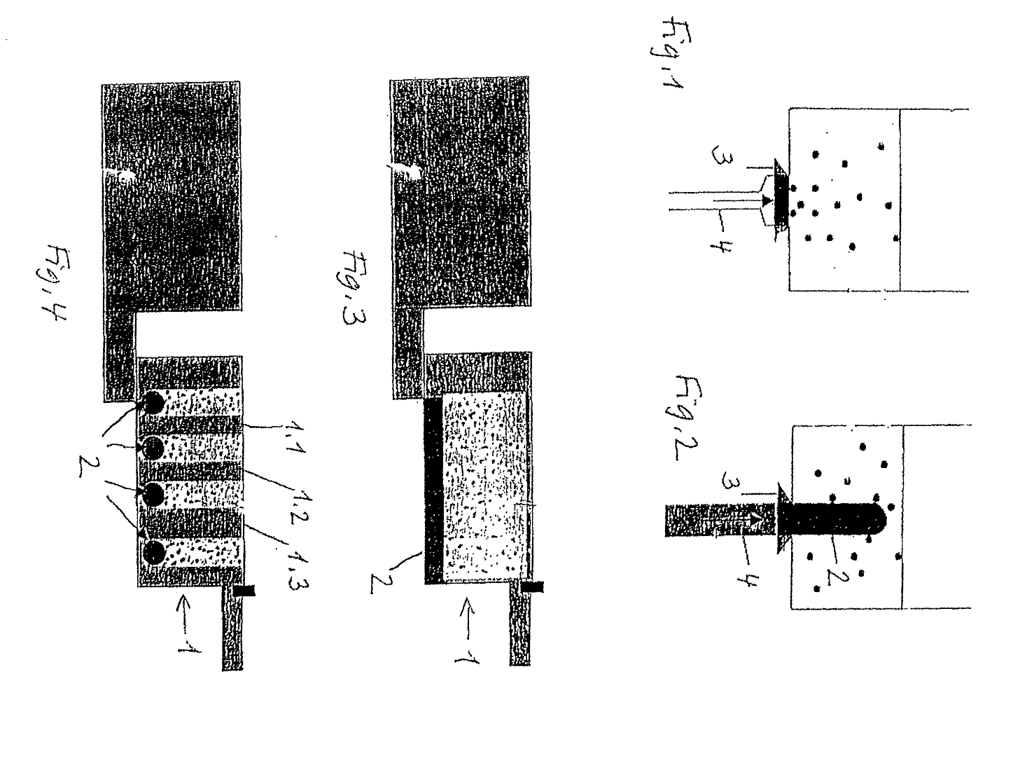

FIG. 1 shows a purification vessel in the form of a platinum crucible with a disc-shaped porous body.

FIG. 2 shows a purification vessel, again in the form of a platinum crucible, with a porous body in the shape of a pipe.

FIG. 3 shows a unit for melting and purifying, with a porous tub bottom.

FIG. 4 shows a unit for melting and purifying, with porous bubbling pipes.

The crucible 1 shown in FIG. 1 contains a mass of molten glass. It displays a porous body 2, which has a plate-shaped configuration. The porous body 2 is designed as a circular disk and sits in a corresponding recess in the platinum crucible 1. It is sealed at its periphery by a fireproof adhesive against the bottom of the platinum crucible 1.

The porous body 2 is connected to a pressurized-gas container (not shown here) via a supply line 4. The pressurized-gas container holds, for example, pressurized air or oxygen.

The platinum crucible 1 shown in FIG. 2 is provided with a porous body, which displays the shape of a sleeve. The sleeve is closed off at its upper end, and is open at its lower end, so that, once again via a supply line 4, gas can be fed into the interior of the sleeve 2. Here, once again, provision is made for a fireproof adhesive 3 as a seal.

In the case of the embodiment for according to FIG. 3, arranged prior to a purification tub 1 is a melting tub 5. The purification tub 1 displays a porous floor 2. This floor thus represents the porous body according to the invention.

In the case of the embodiment for according to FIG. 4, again arranged prior to a purification tub 1 is a melting tub 5. The purification tub 1 is provided with separating walls 1.1, 1.2, 1.3, which subdivide the interior of the purification tub 1 into chambers. On the bottom of the chambers lie pipes 2 of a porous material. These serve as bubbling pipes according to the invention. In the following cases, these run horizontally.

It can also be advantageous to start the fine bubbling already in the melting tub, in order to hereby expel gases immediately upon the melting.

Ideal bubbling-purification gases are oxygen or helium. Oxygen and helium are both gases that can be very well reabsorbed by the molten mass itself after the phase of the bubbling, and thus make possible good bubble qualities. In particular in the case of metallic fritted discs, helium can be advantageous, since it has no oxidizing effect on the mesh material.

1. Device for purifying molten glass;

1.1 with a bubble dispenser for generating gas bubbles from an external gas source as well as for introducing these gas bubbles into the molten mass;

1.2 with a pressurized-gas source arranged prior to the bubble dispenser;

1.3 the bubble dispenser comprising a porous body with open pores;

1.4 the pores of the porous body 2 having an average diameter of less than 0.5 mm.

2. Device according to claim 1, characterized by the fact that the pores of the porous body 2 have an average diameter of less than 100 μm.

3. Device according to claim 1 or 2, characterized by the fact that the porous body 2 is disk-or plug-shaped.

4. Device according to claim 1 or 2, characterized through the following features:

4.1 the porous body (2) is sleeve-shaped;

4.2 the porous body (2) can be installed in a purification vessel (1) such that it protrudes into the molten mass;

4.3 the porous body (2) connectable with its one end to the pressure source, while its other end is closed.

5. Device according to one of the claims 1 through 4, characterized by the fact that the porous body (2) consists of porous material.

6. Device according to one of the claims 1 through 4, characterized by the fact that the porous body (2) displays a lattice, mesh, grid, or grating structure.

7. Device according to one of the claims 1 through 6, characterized by the fact that the porous body (2) consists of ceramic material.

8. Device according to claim 7, characterized by the fact that the porous body (2) consists of one of the following materials:
silicon carbide;
aluminum oxide;
silicon dioxide;
aluminum silicate.

9. Device according to one of the claims 1 through 6, characterized by the fact that the porous body (2) consists of a metal.

10. Device according to claim 9, characterized by the fact that the porous body (2) consists of one of the following materials:
tungsten;
molybdenum;
platinum;
iridium;
or an alloy of these metals.

11. Device according to claim 9 or 10, characterized by the fact that the porous body (2) can be electrically heated.

12. Arrangement for purifying molten glass;

12.1 with a purification vessel;

12.2 with a bubble dispenser for generating gas bubbles from an external pressurized-gas source as well as for introducing the gas bubbles into the molten mass;

12.3 the bubble dispenser comprising a porous body (2) according to one of the claims 1 through 11.

13. Device and method for purifying molten gas according to claims 1 through 11, characterized by the fact that used as the bubbling gas is oxygen.

14. Device and method for purifying molten gas according to claims 1 through 11, characterized by the fact that used as the bubbling gas is helium.
